(19) United States
(12) Patent Application Publication
(10) Pub. No.: US 2006/0184832 A1
(43) Pub. Date: Aug. 17, 2006

(54) Method and apparatus for achieving high cycle/trace compression depth by adding width

(75) Inventors: Michael Stephen Floyd, Austin, TX (US); Larry Scott Leitner, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 11/055,801

(22) Filed: Feb. 11, 2005

(51) Int. Cl. G06F 11/00

(52) U.S. Cl. 714/45

(57) ABSTRACT

A trace array with added width is provided. Each trace array entry includes a data portion and a side counter portion. When a programmable subset of trace data repeats, a side counter is incremented. When the programmable subset of the trace data stops repeating, the trace data and the side counter value are stored in the trace array. The trace array may also include a larger counter. In this implementation, if the smaller side counter reaches its maximum value, a larger counter may begin counting. The larger counter value may then be stored in its own trace array entry instead of the trace data. A predetermined side counter value may mark the entry as a larger compression counter instead of as a data entry.

### BACKGROUND OF THE INVENTION

1. Technical Field

The present invention relates to data processing and, in particular, to event recording. Still more particularly, the present invention provides a method and apparatus for achieving high cycle/trace compression depth by adding width to a trace array.

2. Description of Related Art

Transient event recorders refer to a broad class of systems that provide a method of recording, for eventual analysis, signals or events that precede an error or failure condition in electronic, electromechanical, and logic systems. Analog transient recorders have existed for years in the form of storage oscilloscopes and strip chart recorders. With the advent of low cost high-speed digital systems and the availability of high-speed memory, it became possible to record digitized analog signals or digital signals in a non-volatile digital memory. Two problems that have always existed in these transient event-recoding systems are the speed of data acquisition and the quality of connection to signals being recorded. Transient event recording systems had to have circuits and recording means that were faster than the signals that were to be recorded, and the signal interconnection could not cause distortion or significant interference with desired signals.

Digital transient event recording systems have been particularly useful in storing and displaying multiple signal channels where only timing or state information is important and many such transient event recording systems exist commercially. With the advent of very large-scale integrated circuits (VLSI), operating at high speeds, it became very difficult to employ transient event recording techniques using external instrumentation. The signals to be recorded or stored could not be contacted with an external connection without degradation in performance. To overcome the problems of some prior trace event recorders, trace arrays have been integrated onto VLSI chips along with other functional circuits. Another problem that occurs when trying to use transient event recording techniques for VLSI circuits is that the trigger event, which actually begins a process leading to a particular failure, sometimes manifests itself onto VLSI chips many cycles ahead of the observable failure event.

For hardware debugging of a logic unit in a VLSI microprocessor, a suitable set of control and/or data signals may be selected from the logic unit and put on a bus called the unit debug bus. The contents of this bus at successive cycles may be saved in a trace array. Since the size of the trace array is usually small, it can save only a few cycles of data from the debug bus. Events are defined to indicate when to start and when to stop storing information in the trace array. For example, an event trigger signal may be defined when debug bus content matches a predetermined bit string “A.” A debug bus is the name for a bus used to direct signals to a trace array. For example, bit string “A” may indicate that a cache write to a given address took place and this indication may be used to start a trace (storing data in the trace array). Other content, for example bit string “B,” may be used to stop storing in the trace array when it matches content of the debug bus.

In some cases, the fault in the VLSI chip manifests itself at the last few occurrences of an event (for example, during one of the last times that a cache write takes place to a given address location, the cache gets corrupted). It may not be known exactly which of these last few occurrences of the event manifested the actual error, but it may be known (or suspected) that the error was due to one of the last occurrences. Sometimes there is no convenient start and stop event for storing in the trace array. Because of this, it is difficult to capture the trace that shows the desired control and data signals for the cycles immediately before the last few occurrences of the events. This may be especially true if system or VLSI behavior changes from one program run to the next.

The performance of VLSI chips is difficult to analyze and failures that are transient, with a low repetition rate, are particularly hard to analyze and correct. Problems associated with analyzing and correcting design problems that appear as transient failures are further exacerbated by the fact that the event that triggers a particular failure may occur many cycles before the actual transient failure itself. There is, therefore, a need for a method and system for recording those signals that were instrumental in causing the actual transient VLSI chip failure.

### SUMMARY OF THE INVENTION

The present invention recognizes the disadvantages of the prior art and provides a trace array with added width. Each trace array entry includes a data portion and a side counter portion. When trace data (or programmable subset of trace data that the hardware is programmed to “care” about) repeats, a side counter is incremented. When the trace data (or subset of the trace data) stops repeating, the trace data and the side counter value are stored in the trace array. The trace array may also include a larger counter. In this implementation, if the smaller side counter reaches its maximum value, the larger counter may begin counting. The larger counter value may then be stored in its own trace array entry instead of the trace data. A predetermined side counter value may mark the entry as a larger compression counter instead of as a data entry. For example, a side counter value of all zeros in a trace entry may indicate that the trace entry data is a counter value for the trace data in the previous entry. By increasing the width of the trace array to include a side counter value in each trace entry, the effective depth of the trace array, i.e. the total number of cycles that can be traced, is increased by a significant amount since more entries are made available to trace data instead of small compression count values.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a data processing system in which the present invention may be implemented;

FIG. 2 is a block diagram of a transient event recording system;

FIG. 3 is a block diagram of a transient event recording system according to an exemplary embodiment of the present invention;

FIG. 4 is a block diagram of event logic used in an event recording system according to an embodiment of the present invention;

FIG. 5 is a block diagram of an indexing unit used in an event recording system according to embodiments of the present invention;

FIG. 6 is a block diagram illustrating a trace array in accordance with an exemplary embodiment of the present invention;

FIG. 7 illustrates an example linear feedback shift register; and

FIG. 8 is a flowchart of the operation of a trace array in accordance with an exemplary embodiment of the present invention.

### DETAILED DESCRIPTION OF THE PREFERRED EMBODIMENT

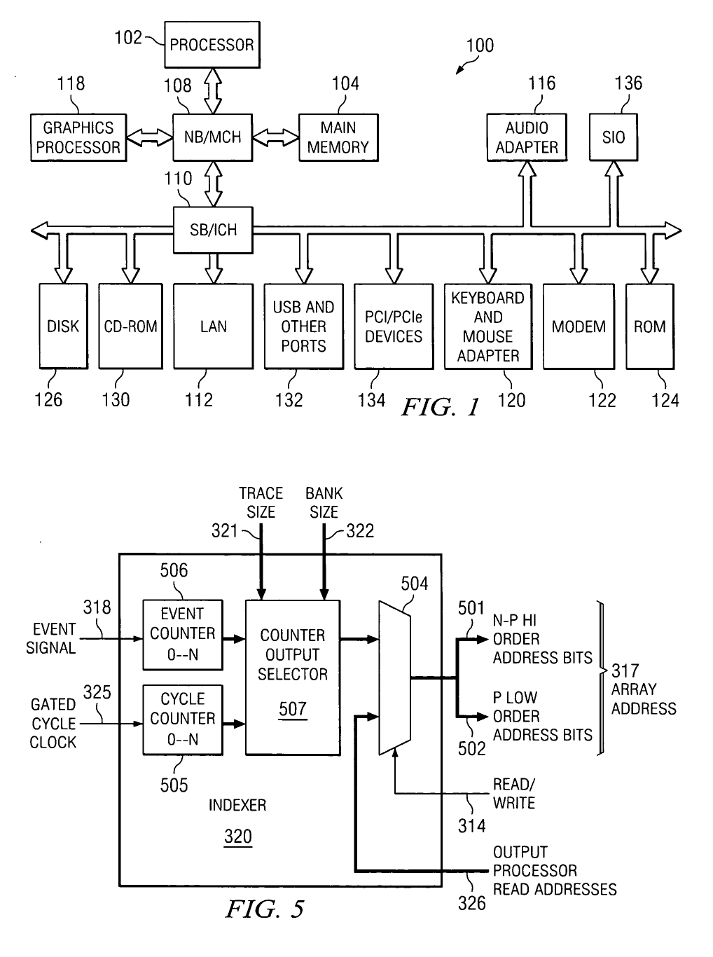

The present invention provides a method and apparatus for achieving high cycle/trace compression depth by adding width to a trace array. The exemplary aspects may be embodied in a data processing device that may be a stand-alone computing device or may be a distributed data processing system in which multiple computing devices are utilized to perform various aspects of the present invention. Therefore, the following FIG. 1 is provided as an exemplary diagram of a data processing environment in which the present invention may be implemented. It should be appreciated that FIG. 1 is only exemplary and is not intended to assert or imply any limitation with regard to the environments in which the present invention may be implemented. Many modifications to the depicted environment may be made without departing from the spirit and scope of the present invention.

With reference now to FIG. 1, a block diagram of a data processing system is shown in which the present invention may be implemented. Data processing system 100 is an example of a computer in which exemplary aspects of the present invention may be located. In the depicted example, data processing system 100 employs a hub architecture including a north bridge and memory controller hub (MCH) 108 and a south bridge and input/output (I/O) controller hub (ICH) 110. Processor 102, main memory 104, and graphics processor 118 are connected to MCH 108. Graphics processor 118 may be connected to the MCH through an accelerated graphics port (AGP), for example.

In the depicted example, local area network (LAN) adapter 112, audio adapter 116, keyboard and mouse adapter 120, modem 122, read only memory (ROM) 124, hard disk drive (HDD) 126, CD-ROM driver 130, universal serial bus (USB) ports and other communications ports 132, and PCI/PCIe devices 134 may be connected to ICH 110. PCI/PCIe devices may include, for example, Ethernet adapters, add-in cards, PC cards for notebook computers, etc. PCI uses a cardbus controller, while PCIe does not. ROM 124 may be, for example, a flash binary input/output system (BIOS). Hard disk drive 126 and CD-ROM drive 130 may use, for example, an integrated drive electronics (IDE) or serial advanced technology attachment (SATA) interface. A super I/O (SIO) device 136 may be connected to ICH 110.

An operating system runs on processor 102 and is used to coordinate and provide control of various components within data processing system 100 in FIG. 1. The operating system may be a commercially available operating system such as Windows XP™, which is available from Microsoft Corporation. An object oriented programming system, such as Java™ programming system, may run in conjunction with the operating system and provides calls to the operating system from Java™ programs or applications executing on data processing system 100. “JAVA” is a trademark of Sun Microsystems, Inc. Instructions for the operating system, the object-oriented programming system, and applications or programs are located on storage devices, such as hard disk drive 126, and may be loaded into main memory 204 for execution by processor 102. The processes of the present invention are performed by processor 102 using computer implemented instructions, which may be located in a memory such as, for example, main memory 104, memory 124, or in one or more peripheral devices 126 and 130.

Those of ordinary skill in the art will appreciate that the hardware in FIG. 1 may vary depending on the implementation. Other internal hardware or peripheral devices, such as flash memory, equivalent non-volatile memory, or optical disk drives and the like, may be used in addition to or in place of the hardware depicted in FIG. 1. Also, the processes of the present invention may be applied to a multiprocessor data processing system.

Processor 102 may comprise a VLSI chip that has a trace array and associated circuits according to embodiments of the present invention. Logic signals of circuits being debugged are directed to a bus coupled to the input of the trace array and states of the trace signals may be stored and recovered according to embodiments of the present invention.

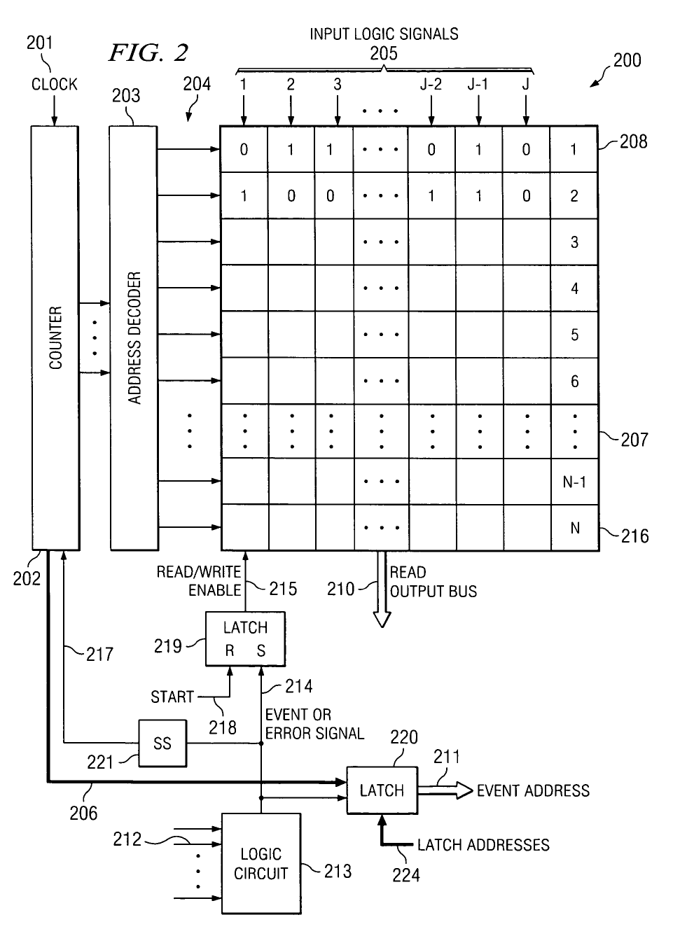

FIG. 2 is a block diagram of a digital transient event recorder 200 that may be used for debugging digital circuits. A memory array (trace array) 207 has entries 208-216 (1 through N) and J input logic signals 205 (1-J). Address decoder 203 addresses the individual entries, e.g., entry 208, with address signals 204. A counter 202, for example, may be used to sequence through the N-addresses of trace array 207. Counter 202 receives clock input 201 and is configured to automatically reset to zero (entry one) and count up to (N-1) (N^{th} entry) when it reaches the end of its count (N-1). In this manner, the addresses for trace array 207 cycle from one to N and then repeat.

If read/write enable (R/W) 215 is set to write, then trace array 207 records in a wrapping mode with old data being overwritten by new data. Clock 201 converts the entries one through N to a discrete time base where trace array 207 stores the states of logic input signals 205 at each discrete time of the clock 201. If read/write enable 215 is set to read, then as counter 202 causes the addresses 204 to cycle, the contents of trace array 207 may be read out in parallel via read output bus 210. If an edge triggered single shot (SS) circuit 221 is used to generate a reset 217 to counter 202 each time read/write enable 215 changes states, then counter 202 starts at a zero count (entry one) and trace array 207 is read from or written to starting from address one. In the read mode, trace array 207 is continuously read out cycling from entry 208 through 216 and back to entry 208. The write mode likewise loops through the addresses and new data overwrites old data until an error or event signal 214 resets latch 219 and trace array 207 is set to the read mode.

Trace array 207 retains the N-logic state time samples of logic inputs 205, which occurred preceding the error or event 214. The error or event 214 may be generated by a logic operation 213 on inputs 212. The outputs of counter 202 are also coupled to parallel latch 220. When error or event 214 occurs, the counter 202 outputs and thus the address of trace array 207 being written into is latched in latch 220 storing event address 211. Event address 211 may be compared to the counter output during a cyclic read of trace array 207 to determine the actual logic states of logic inputs 205 when the error or event signal 214 occurred. Event address 211 may also be stored in a circuit that may be indexed up or down around event address 211 to generate a signal to synchronize with time samples of logic input 205 before event signal 214.

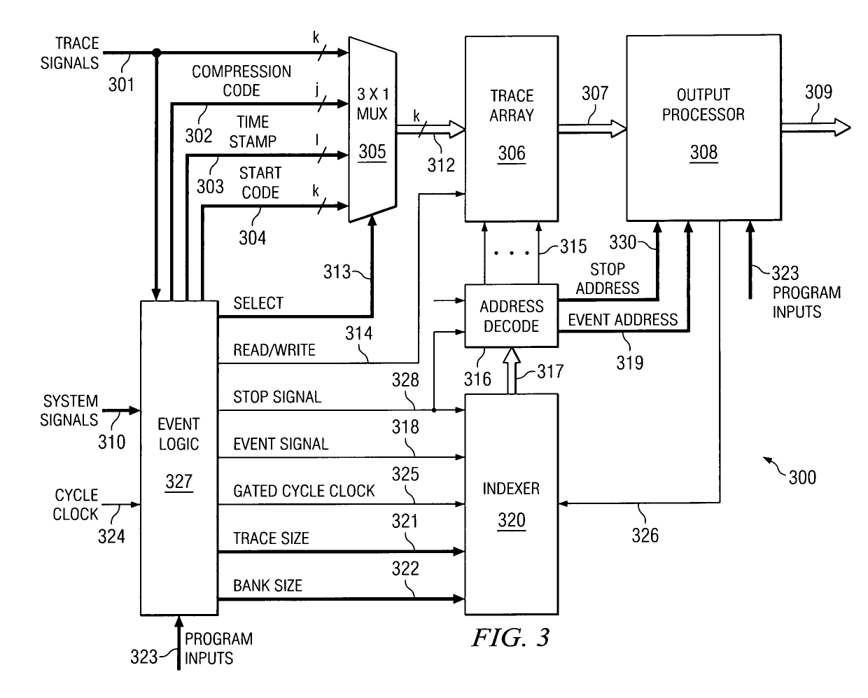

FIG. 3 is a block diagram of a transient event recorder 300 using a trace array 306 according to embodiments of the present invention. Trace array 306 has k inputs (receiving k outputs 312) and is configured to store “N” uncompressed signal states. Trace signals 301 are coupled to trace array 306 via multiplexer (MUX) 305. Select signal 313 determines which of the trace signals 301, start code 304, or a combination of compression code 302 and time stamp 303 are recorded in trace array 306. Compression code 302 is recorded as either a pattern that does not likely occur in normal recording or a unique code.

A compression code 302 is written to indicate that no transition has occurred in any of a programmable selected (program inputs 323) number of trace signals 301 at a particular time of cycle clock 324. A masking function in event logic 327 may be used to select which of trace signals 301 to monitor for the compression function. Time stamp 303 stores a count (in place of trace signals 301) corresponding to the number of cycles of cycle clock 324 in which no selected trace signal 301 changed state.

Start code 304 is a code written in trace array 306 (in place of trace 301 signals) indicating where recording was started in all or a portion (sub-array or Bank) of trace array 306. As such, a start code 304 will be overwritten if recording continues for an extended period because of the cyclic nature of recording in the trace array 306 or a Bank (e.g., 601-604) of trace array 306. Event logic 327 is used to generate logic combinations of system signals 310, which indicate particular events of interest, for example, event signal 318 and stop signal 328. Program inputs 323 may be used to change or select which system signals 310 are used to generate an event signal 318 for a particular trace recording. Program inputs 323 may also be used to select the Bank size signals 322 relative to trace size signals 321.

If the trace array 306 is able to store N uncompressed signal states, where 2^{M} equals N, then an M-bit counter would be sufficient to generate all addresses for accessing trace array 306. If it is desired to partition the N-position trace array into Banks of size 2^{P} (where P is equal to an integer<M), then the number of Banks that may be partitioned in trace array 306 (of size 2^{M}) may be expressed as 2^{M-P}.

Trace size signals 321 and Bank size signals 322 are coupled to indexer 320 and are used to direct outputs 317 that generate addresses 315 via the address decode 316. Event signal 318 and stop signal 328 may be coupled to the address decode 316 to direct the particular stop address 330 and event addresses 319, which may be stored by output processor 308.

In other embodiments of the present invention, the stop address 330 is retained simply by not indexing the address counters (event counter 506 and cycle clock counter 505) after receipt of a stop signal 318 and starting readout from the stop address 330. Since the trace array addresses 317, corresponding to an event signal 318, are important in reconstructing sequences readout of trace array 306, output processor 308 may be used to store event storage addresses 319 and a stop address 330. Output processor 308 is used to reconstruct stored trace signals 301 that have been compressed according to embodiments of the present invention.

It is important to note that exemplary output processor 308 in FIG. 3 is an example of a hardware implementation. Other embodiments of the present invention implement the function of the output processor 308 with software instructions or script code. With a software output processor, code would determine where and how stop address 330 and event address 319 are to be stored or tracked to reconstruct the trace signal data 301 during read out. Likewise, the signals 326 directing indexer 320 to generate appropriate trace array addresses for read out may be generated by a portion of the software code generating the function of output processor 308. The signal states (trace signals 301) and the codes (e.g., start code 304, time stamp 303, and compression code 302) stored in trace 306 array may be read with a hardware output processor 308 or software code providing the output processing function according to embodiments of the present invention. The output processing function (hardware or software) may be physically external to the processor containing the trace array 306 and still be within the scope of the present invention. Output 309, which represents signals corresponding to the reconstructed readout of trace array 306, may be used to analyze or debug operations of the system.

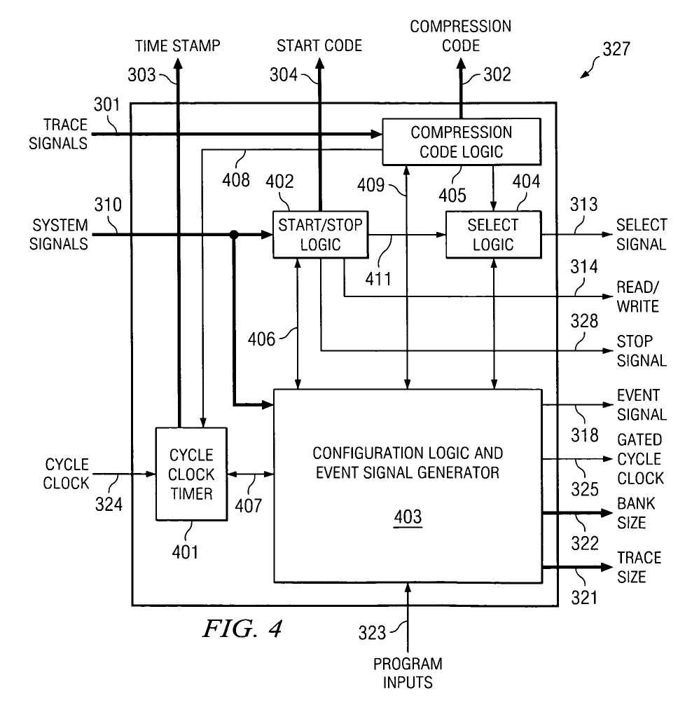

FIG. 4 is a block diagram of exemplary logic elements, which may be included within event logic 327. FIG. 4 illustrates in more detail how various signals may be generated. Trace signals 301 are processed by compression logic 405 to determine if at least one selected trace signal 301 (masking function) has a state change at each cycle clock 324 time. If there is no state change on any of the selected trace signals 301, then the value of time stamp 303 is incremented and cycle clock counter 401 is not incremented. Time stamp 303 accumulates a count corresponding to the number of cycles of cycle clock 324 which occur without any selected trace signal 301 changing state. Compression logic 405 and start/stop logic 402 signal select logic 404 to generate the appropriate select signal 313 to gate multiplexer (MUX) 305. If no selected trace signal 301 is changing state, then select signal 313 directs that compression code 302 and time stamp 303 be written in place of trace signal 301 states. When at least one of selected trace signals 301 again changes state, the time stamp 303 and compression code 302 are then stored (written) in trace array 306 in place of states of trace signals 301.

Configuration logic and event signal generator (CLEV) 403 have exemplary logic circuits that receive program inputs 323, system signals 310, signals 406 from start/stop logic 402, and signals 409 from compression code logic 405 and generate outputs for other logic blocks, for example event signal 318, gated cycle clock 325, Bank size signals 322 and trace size signals 321. Compression logic 405 signals (signals 408) cycle clock timer 401 when no state changes occur in selected trace signals 301 and cycle clock time 401 signals CLEV 403 via signals 407 to send gated cycle clock 325 to indexer 320. Start/stop logic 402 receives system signals 310 and signals 460 from CLEV logic 403 and generates a read/write signal 314 for trace array 306 and outputs 411 for select logic 404.

Select logic 404 generates a select signal 313 that directs appropriate outputs 312 of MUX 305 to trace array 306. In this manner, a start code 304, compression code 302, time stamp 303 and trace signals 301 are selectively recorded in trace array 306. Logic included in start/stop logic 402 receives system signals 310, outputs 406, and determines when to indicate the start of (start code 304) trace signal 301 recording, when to stop recording trace signals 301 (stop signal 328), and when to write or readout (read/write 314) states of trace signals 301 in trace array 306.

FIG. 5 is a more detailed block diagram of exemplary logic in an indexer 320. Indexer 320 generates trace array addresses 317, which may be decoded (if necessary), to access particular storage locations in trace array 306 during a read or a write operation. In one embodiment of the present invention, event signal 318 is received in a binary event counter 506, which is configured to count up (from zero to N-1) where N is the entry size of trace array 306. Since the states of selective bits of a binary counter repeat, for example the lowest order bit repeats every two counts and the two lowest order bits repeat every four counts, monitoring only selective bits has the effect of a circular counter where a “reset” to an initial count is automatic. If all N-outputs of event counter 506 are monitored, the output pattern would repeat after N-counts.

Event counter 506 counts event signal 318, which represents predetermined (e.g., by program inputs 323) conditions of interest in a system having trace signals 301. Event signal 318 may be generated by a logic combination of system signals 310 in CLEV 403. Cycle clock counter 505 counts gated cycle clock 325. Gated cycle clock 325 is generated by simply gating (e.g., logic AND) cycle clock 324 with a logic signal from compression logic 405. As long as at least one selected trace signal 301 changes state at each cycle clock 324 time, gated cycle clock 325 follows cycle clock 324.

Whenever compression logic 405 determines that no selected trace signal 301 changes state, then gated cycle clock 325 is turned off. While gated cycle clock 325 is off, trace array addresses 317 changes only if an event signal 318 occurs. When compression logic 405 determines that selected ones of trace signals 301 have state changes, then gated cycle clock 325 is turned on and trace array addresses 317 again increment each cycle clock 325 time. It should be noted that other counter configurations, along with any necessary address decoder 316, may be used to generate trace addresses 317 and still be within the scope of the present invention.

For the exemplary indexer 320 in FIG. 5, counter output selector 507 selects outputs of event counter 506 and cycle counter 505 to form the high order address bits 501 and the low order address bits 502 of the trace array addresses 317. Counter output selector 507 receives trace size signal 321 data and Bank size signal 322, generated from program inputs 323, and determines which outputs of event counter 506 and cycle counter 505 to use to form trace array addresses 317. Event signal 318 indexes event counter 506 and generates the high order bits of array addresses 317, thus effectively partitioning trace array 306 into sub-arrays or Banks when directed by program inputs 323. Between event signals 318, the trace array addresses 317 are repeated within the Bank determined by the count in event counter 506.

In FIG. 5, both event counter 506 and cycle clock counter 505 are shown as size “N” (the size of trace array 306); therefore, trace array 306 may be effectively partitioned as one trace array 306 (one Bank) with N entries or N Banks of one entry. While N Banks of one entry may not be of much practical interest, it would be a possibility in the embodiment shown in FIG. 5. Trace size signal 321 and Bank size signal (number of Banks) 322 are inputted from program data 323 based on the needs of a given trace operation.

FIGS. 2-5 illustrate an example trace array architecture with compression. The operation of the trace array architecture is described in further detail in U.S. Pat. No. 6,802,031, entitled “METHOD AND APPARATUS FOR INCREASING THE EFFECTIVENESS OF SYSTEM DEBUG AND ANALYSIS,” issued Oct. 5, 2004, having the same assignee as the instant application, and hereby incorporated by reference.

Returning to FIG. 3, trace array 306 may be a k by N array, where k is the number of bits in a trace entry and N is the depth of the array. For example, each trace entry may be 64 bits wide (k) and the trace array may store 128 entries (N). Each entry may store trace data; however, as discussed above with reference to FIGS. 2-5, an entry may also store compression data. While compression may increase the usefulness of the area of the trace array, one may still wish to increase the depth of the trace array to store even more entries. It is important to save as many cycles of data as possible so that an engineer has as much history as possible on the events leading up to a failure. Unfortunately, silicon area on a VLSI device, such as a processor, is at a premium. Therefore, simply doubling the depth (N) of the array is not always feasible.

In accordance with exemplary aspects of the present invention, the depth of the trace array is increased by adding width to the trace array. Each trace array entry includes a data portion and a side counter portion. When trace data (or programmable subset of the trace data) repeats, a side counter is incremented. When the trace data stops repeating, the trace data and the side counter value are stored in the trace array. The trace array may also include a larger counter. Therefore, if the side counter reaches its maximum value, the larger counter may begin counting. The larger counter value may then be stored in its own trace array entry.

A predetermined side counter value may mark the entry as a larger compression counter instead of as a data entry. For example, a side counter value of all zeros in a trace entry may indicate that the trace entry data is a counter value for the trace data in the previous entry. By increasing the width of the trace array to include a side counter value in each trace entry, the effective depth of the trace array, i.e. the total number of cycles that can be traced, is increased by a significant amount since more entries are made available to trace data instead of occupying an entire trace array entry to store small compression count values.

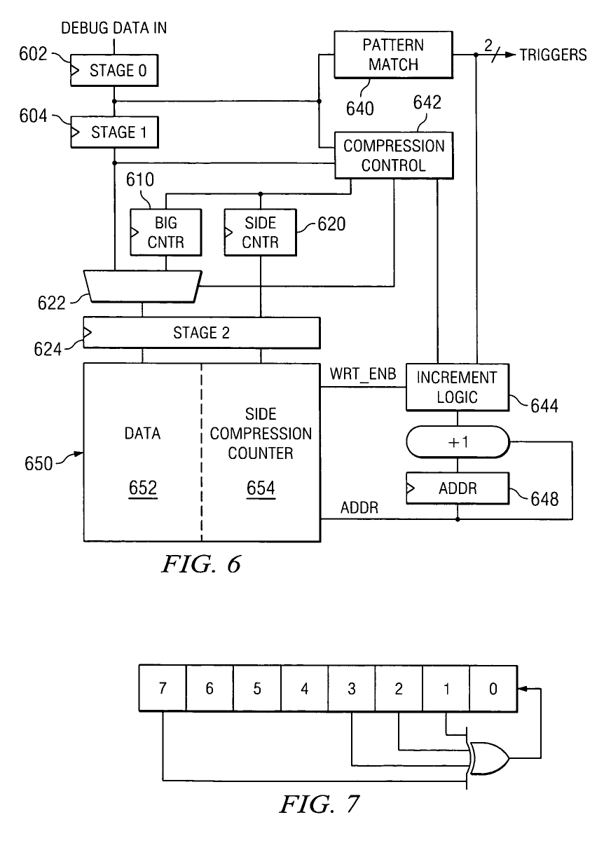

FIG. 6 is a block diagram illustrating a trace array, such as trace array 306 in FIG. 3, in accordance with an exemplary embodiment of the present invention. Debug data is received at stage 0 register 602. At the next clock cycle, the debug data passes to stage 1 register 604. The debug data passes through multiplexer 622 to stage 2 register 624.

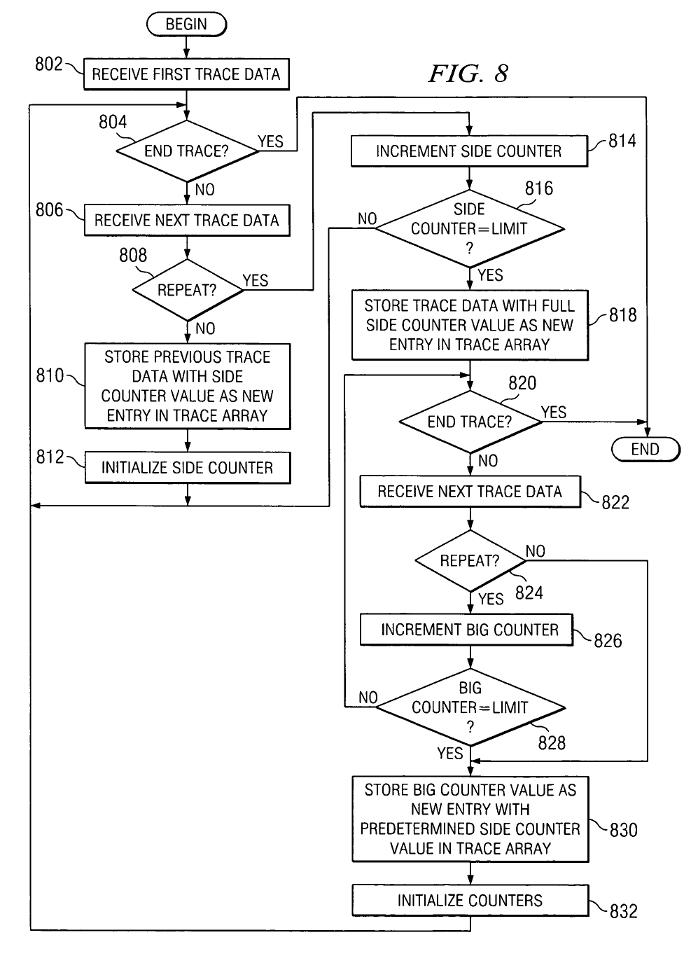

Side counter 620 is initialized with an initial value. For a simple monotonically increasing counter, the initial value is simply one, for example. However, other types of counters may also be used. In one preferred embodiment of the present invention, side counter 620 is a linear feedback shift register (LFSR), as will be described in further detail below with reference to FIG. 7. The initial value of side counter 620 is also passed to stage 2 register 624.

Compression control logic 642 compares debug data at stage 0 602 to debug data at stage 1 604 to determine if the trace data repeats. If the trace data does not repeat, then compression control logic 642 signals increment logic 644 to enable the data in stage 2 624 to be written to trace array 650. Compression control logic 642 times the write for when the non-repeating debug data passes from stage 2 624 to trace array 650. The comparison logic in compression control logic 642 may take multiple cycles to determine a result; therefore, more stages of registers may be included between debug data in and multiplexer 622 for timing purposes. Compression control logic 642 also initializes big counter 610 and side counter 620 when debug data does not repeat.

Furthermore, compression control logic 642 may signal increment logic 644 to write a trace entry when the debug data matches a compression mask. Similarly, pattern match logic 640 may compare debug data in stage 0 602 with a pattern mask and signal increment logic 644 to write a trace entry when debug data matches a pattern mask. Again, the write of a trace entry is timed so that the write takes place when data is passed from stage 2 624 to trace array 650.

Increment logic 644 asserts a write enable signal (WRT_ENB) to write the debug data to data portion 652 and the side counter value to side compression counter portion 654. The WRT_ENB signal may be asserted for two clock cycles to write the data with side counter value in one cycle and then to write the debug data of the next trace entry in the next cycle. Increment logic 644 also increments address register 648, which cycles through the entries in trace array 650. Thus, address register 648 may count from 0 to N-1, where N is the number of entries in trace array 650.

When debug data repeats, compression control logic 642 allows side counter 620 to increment. Increment logic also deasserts the WRT_ENB signal so that entries from stage 2 624 are not written until a non-repeating entry arrives. Then, when a non-repeating entry arrives at stage 2 624, compression control logic 642 instructs increment logic 644 to write the side counter value in side compression counter portion 654. The next cycle, compression control logic 642 instructs increment logic 644 to increment address register 648 and write the debug data for the next entry in data portion 652.

Consider as an example the following sequence of data: A, A, B, C, C, C, C, D, D. When the first debug data appears, A, it is non-repeating because it is the first entry. This data is written in data portion 642 and side counter 620, with a value representing one, is written in side compression counter portion 654. When the second debug data appears, A, compression control logic 642 detects that data repeats and side counter 620 increments. Next, the third debug data appears, B, compression control logic 642 detects that data is not repeating. When the second debug data gets to stage 2, compression control logic 642 signals increment logic 644 to write the value of side counter 620, now representing two, to side compression logic counter portion 654. Then, compression control logic 642 instructs increment logic 644 to write the third debug data in the next trace entry by incrementing address register 648. The resulting trace entries would be as follows:

A|2

B|1

C|4

D|2

In the above example, nine data events are stored as only four trace entries.

Thus, the area of the trace array is increased from a k by N array to a (k+j) by N array, where k is the size of the data, N is the number of trace entries in the trace array, and j is the size of the side counter. Consider as an example a typical case with 256 trace entries with 64 bits of data. Adding 8 bits of width for an 8-bit side counter results in a 12.5% area increase. However, this increase in width may result in the effective depth of the trace array being double or more, depending on the frequency of change in the input data stream. For example in a memory subsystem trace, the transactions being stored in the trace array are “bursty” meaning there are long periods of inactivity followed by small periods of very frequent changes.

Due to the finite size of side counter 620, the side counter may reach a maximum value if the debug data is very repetitive. Compression control logic 642 may detect when side counter 620 reaches maximum value and allow big counter 610 to increment. In this case, compression control logic 642 may signal increment logic 644 to write the trace entry with the maximum side counter value. Then, when data is no longer repeating, compression control logic 642 signals multiplexer 622 to pass the big counter value 610 to stage 2 624. Compression control logic 642 then signals increment logic 644 to write the big counter value in data portion 652. Side compression counter portion 654 may be filled with a compression code, such as all zeros, for example, to signal that the data in data portion 652 is not actual data, but rather a larger counter value. The output processor would then know to add that value to the side counter value from the previous trace entry. Also, when debug data stops repeating, compression control logic 642 initializes big counter 610 and side counter 620.

Consider as an example the following sequence of data: A, A, B, C, C, C, C, and D 1000 times. If the side counter is 8 bits wide, then the maximum value is 255. Therefore, the resulting trace entries would be as follows:

A|2

B|1

C|4

D|255

745|0

Note that the only time the side compression counter portion of a trace entry would take a value of zero is to signal that the data in the data portion of the trace entry is a compression counter value.

As mentioned above, big counter 610 and side counter 620 may be implemented as various types of counters that are well-known in the art. For example, simple monotonically increasing and monotonically decreasing counters are known in the art. However, these counters use a significant number of gates. During runtime, it is best to be as cheap and fast as possible. It is not necessarily important for the counters to be monotonically increasing. Therefore, it would be preferable not to use precious silicon area for the counters when a cheaper (in terms of area) alternative may exist.

A linear feedback shift register (LFSR) is a type of shift register that acts as a pseudo random number generator. An LFSR cycles through all 256 states, except for an all-zeros state in most cases, although solutions exist for allowing an all-zeros state. FIG. 7 illustrates an example linear feedback shift register. The LFSR of FIG. 7 includes eight latches.

The output of the least significant bit, the 0 bit, is received as an input to the second least significant bit, the 1 bit, and so on. The output of the 1 bit, the 2 bit, the 3 bit, and the 7 bit are input to an exclusive OR (XOR) gate, the output of which is received as input to the least significant bit, 0. The LFSR may be initialized, for example, with all ones. The LFSR of FIG. 7 cycles through the following states:

11111111

11111110

11111100

11111000

11110000

11100001

11000011

10000110

00001100

. . .

Thus, during post processing, a LFSR value of “11111111” may be identified as a numerical value of 1 and a LFSR value of “10000110” may be identified as a numerical value of 8. For example, a look-up table may be used to map LFSR values to numerical values.

LFSRs may be used in place of the big counter and the side counter in the trace array of FIG. 6. For example, an 8-bit LFSR may be used in place of side counter 620 and a 48- or 64-bit LFSR may be used in place of big counter 610. As seen in FIG. 7, a LFSR may include a single XOR gate, thus taking up less silicon area. While the LFSR shown in FIG. 7 is an 8-bit LFSR, similar circuits exist for 48- or 64-bit LFSRs.

FIG. 8 is a flowchart of the operation of a trace array in accordance with an exemplary embodiment of the present invention. Operation begins and the trace array receives the first trace data (block 802). A determination is made as to whether to end the trace (block 804). If a signal indicates that the trace is to be ended, operation ends. If, however, a signal indicating that the trace is to be ended is not received in block 804, then the trace array receives the next trace data (block 806).

Compression control logic determines whether the trace data repeats (block 808). This determination may be made, for example, by comparing the first trace data with the next trace data. If trace data does not repeat, the compression control logic stores the previous trace data with a side counter value as a new entry in the trace array (block 810). For the first trace data, the side counter is an initial value representing one. However, for subsequent trace data events, the side counter may increment to a value representing the number of times the trace data has occurred in succession. Then, the compression control logic initializes the side counter (block 812) and operation returns to block 804 to determine whether to end the trace.

If the trace data repeats in block 808, the side counter increments (block 814) and a determination is made as to whether the side counter reaches a maximum value (block 816). If the side counter does not reach the limit, operation returns to block 804 to determine whether to end the trace.

If the side counter reaches the maximum value in block 816, the compression control data stores the trace data with the full side counter value as a new entry in the trace array (block 818). Then, a determination is made as to whether to end the trace (block 820). If a signal indicates that the trace is to be ended, operation ends. If, however, a signal indicating that the trace is to be ended is not received in block 820, then the trace array receives the next trace data (block 822).

Next, compression control logic determines whether the trace data repeats (block 824). If the trace repeats, the compression control logic increments the big counter (block 826) and determines whether the big counter reaches a limit (block 828). It is unlikely that the big counter will reach its limit; however, in such a case, the compression control logic stores the big counter value as a new entry with a predetermined value in the side counter portion of the entry in the trace array (block 830). Thereafter, the big counter and the side counter are initialized (block 832) and operation returns to block 804 to determine whether to end the trace.

If trace data does not repeat in block 824, the compression control logic stores the big counter value as a new entry with a predetermined value in the side counter portion of the entry in the trace array (block 830). Thereafter, the big counter and the side counter are initialized (block 832) and operation returns to block 804 to determine whether to end the trace.

Thus, the present invention solves the disadvantages of the prior art by providing a trace array with added width. Each trace array entry includes a data portion and a side counter portion. When trace data (or programmable subset of trace data that the hardware is programmed to “care” about) repeats, a side counter is incremented. When the trace data (or subset of the trace data) stops repeating, the trace data and the side counter value are stored in the trace array. The trace array may also include a larger counter. In this implementation, if the smaller side counter reaches its maximum value, the larger counter may begin counting. The larger counter value may then be stored in its own trace array entry instead of the trace data.

A predetermined side counter value may mark the entry as a larger compression counter instead of as a data entry. For example, a side counter value of all zeros in a trace entry may indicate that the trace entry data is a counter value for the trace data in the previous entry. By increasing the width of the trace array to include a side counter value in each trace entry, the effective depth of the trace array, i.e. the total number of cycles that can be traced, is increased by a significant amount since more entries are made available to trace data instead of small compression count values.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for providing a trace, the method comprising:
providing a plurality of entries in a trace array, wherein each entry in the trace array includes a data portion and a counter portion;
incrementing a counter each time a programmable subset of trace data repeats;
responsive to the programmable subset of trace data stopping repeating, storing the programmable subset of trace data in the data portion of a trace entry and storing contents of the counter in the counter portion of the trace entry.

2. The method of claim 1, wherein the counter is a linear feedback shift register.

3. The method of claim 1, wherein the counter is a first counter, the method further comprising:
responsive to the first counter reaching a maximum value, storing the programmable subset of trace data in the data portion of a first trace entry, storing contents of the first counter in the counter portion of the first trace entry, and incrementing a second counter each time a programmable subset of trace data repeats.

4. The method of claim 3, the method further comprising:
responsive to the programmable subset of trace data stopping repeating, storing contents of the second counter in the data portion of a next trace entry and storing a predetermined value in the counter portion of the next trace entry.

5. The method of claim 4, wherein the predetermined value is a zero value.

6. The method of claim 4, wherein the second counter is a linear feedback shift register.

7. An apparatus for providing a trace, the apparatus comprising:
means for providing a plurality of entries in a trace array, wherein each entry in the trace array includes a data portion and a counter portion;
means for incrementing a counter each time a programmable subset of trace data repeats;
means, responsive to the programmable subset of trace data stopping repeating, for storing the programmable subset of trace data in the data portion of a trace entry and storing contents of the counter in the counter portion of the trace entry.

8. The apparatus of claim 7, wherein the counter is a first counter, the apparatus further comprising:
means, responsive to the first counter reaching a maximum value, for storing the programmable subset of trace data in the data portion of a first trace entry, storing contents of the first counter in the counter portion of the first trace entry, and incrementing a second counter each time a programmable subset of trace data repeats.

9. The apparatus of claim 8, the apparatus further comprising:
means, responsive to the programmable subset of trace data stopping repeating, for storing contents of the second counter in the data portion of a next trace entry and storing a predetermined value in the counter portion of the next trace entry.

10. The apparatus of claim 9, wherein the predetermined value is a zero value.

11. An apparatus for providing a trace, the apparatus comprising:
a trace array, wherein each entry in the trace array includes a data portion and a counter portion;
a side counter; and
compression logic, wherein the compression logic increments the side counter each time a programmable subset of trace data repeats,
wherein the compression logic, responsive to the programmable subset of trace data stopping repeating, stores the programmable subset of trace data in the data portion of a trace entry and stores contents of the counter in the counter portion of the trace entry.

12. The apparatus of claim 11, wherein the counter is a linear feedback shift register.

13. The apparatus of claim 11, further comprising:
a second counter,
wherein the compression logic, responsive to the first counter reaching a maximum value, stores the programmable subset of trace data in the data portion of a first trace entry, stores contents of the side counter in the counter portion of the first trace entry, and increments a second counter each time a programmable subset of trace data repeats.

14. The apparatus of claim 13, wherein the compression logic, responsive to the programmable subset of trace data stopping repeating, stores contents of the second counter in the data portion of a next trace entry and stores a predetermined value in the counter portion of the next trace entry.

15. The apparatus of claim 14, wherein the predetermined value is a zero value.

16. The apparatus of claim 14, wherein the second counter is a linear feedback shift register.
